(19) United States
(12) Patent Application Publication
(10) Pub. No.: US 2020/0406552 A1
(43) Pub. Date: Dec. 31, 2020

(54) DETECTION OF ABNORMAL TEMPERATURES FOR THERMAL CONTROL DURING ADDITIVE MANUFACTURING

(71) Applicant: HEWLETT-PACKARD DEVELOPMENT COMPANY, L.P., Spring, TX (US)

(72) Inventors: Juan Carlos Catana Salazar, Zapopan (MX); Sunil Kothari, Palo Alto, CA (US); Jun Zeng, Palo Alto, CA (US); Tod Heiles, Vancouver, WA (US); Barret Kammerzell, Vancouver, WA (US); Elizabeth Stortstrom, Vancouver, WA (US)

(21) Appl. No.: 16/606,763

(22) PCT Filed: Mar. 13, 2018
(86) PCT No.: PCT/US2018/022128

§ 371 Date: Oct. 20, 2019

(51) Int. Cl. B29C 64/386; B29C 64/245

(52) U.S. Cl. CPC B29C 64/386; B33Y 30/00; B29C 64/245

(57) ABSTRACT

A method is disclosed in which an abnormal temperature is detected based on analysis of temperature data received from a sensor disposed in a target zone, where the target zone is to receive build material for additive manufacture of multiple substantially similar parts. The abnormal temperature is replaced with an estimated temperature based on the analysis.

### BACKGROUND

Parts generated during additive manufacturing (AM) depend on appropriate thermal control and management during the printing process to ensure the part has one or more desired properties. Each layer of the AM part may involve multiple operations, such as powder spreading, liquid deposition, and one or more fusing stages.

Real-time control and feedback for AM utilizes a sensor sampling timely readings of the powder and part temperature and actuation of the agents and/or the lamp pulse width modulators (PWMs) for corrective action. For the corrective action to be accurate, abnormal values should be detected and rule out.

Some corrective actions on the raw sensor data, such as lamp exposure time compensation and non-destructive testing methods, such as correlation analyses, are not available when sensor data is missing.

### BRIEF DESCRIPTION OF THE DRAWINGS

Certain examples are described in the following detailed description and in reference to the drawings, in which:

FIG. 1 is a simplified block diagram of a method for estimating a temperature, according to examples.

FIG. 2 is a simplified diagram of a target zone in which a plurality of substantially similar parts is additive manufactured as part of a single build, according to examples.

FIGS. 3A and 3B are illustrations of a dog bone and a 10×8 array of dog bones printed on a test bed, respectively, according to examples.

FIG. 4 is a simplified illustration of the temperature data gathering of the thermal sensors, according to examples.

FIGS. 5A and 5B are graphs of thermal profile one of the dog bones of FIG. 3, according to examples.

FIG. 6 is a graph featuring profile temperatures of the dog bones in the test bed of FIG. 3, according to examples.

FIG. 7 is a flow diagram illustrating operations performed by the method of FIG. 1 to determine whether estimating temperature is possible, according to examples.

FIG. 8 is a flow diagram showing operations to do temperature estimation, according to examples.

FIG. 9 is a flow diagram showing operations of the carriage obstructed layer detection portion of the method of FIG. 1, according to examples.

FIG. 10 is a flow diagram showing the abnormal temperature detection and method for estimating a temperature, according to examples.

FIGS. 10A and 10B are graphs showing the thermal profile for two different dog bones of FIG. 3, according to examples.

FIGS. 11A-11D are diagrams showing carriage obstruction across four frames, according to examples.

FIG. 12 is a flow diagram illustrating operations performed by the neighborhood trending estimation of the method of FIG. 1, according to examples.

FIGS. 13A and 13B show the matrix of availability for PID 52 and the thermal profile 1300B of the neighborhood of PID 52, according to examples.

FIG. 14 is a flow diagram showing operations performed during historical trending estimation, according to examples.

FIG. 15 is a graph illustrating the thermal profile of PID 34 in frames 1, 2 and 3, according to examples.

FIG. 16 is a flow diagram showing operations of the recommendation engine of the method of FIG. 1, according to examples.

FIGS. 17A-17D are graphs used by the recommendation engine of the method of FIG. 1, according to examples.

FIG. 18 is a diagram of a computer-readable medium implementing the method of FIG. 1, according to examples.

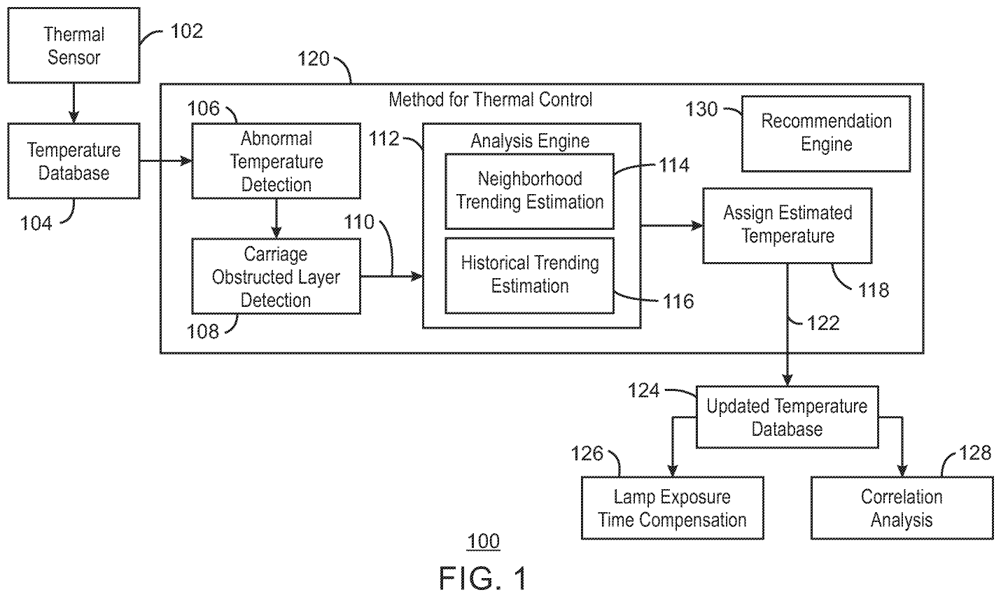

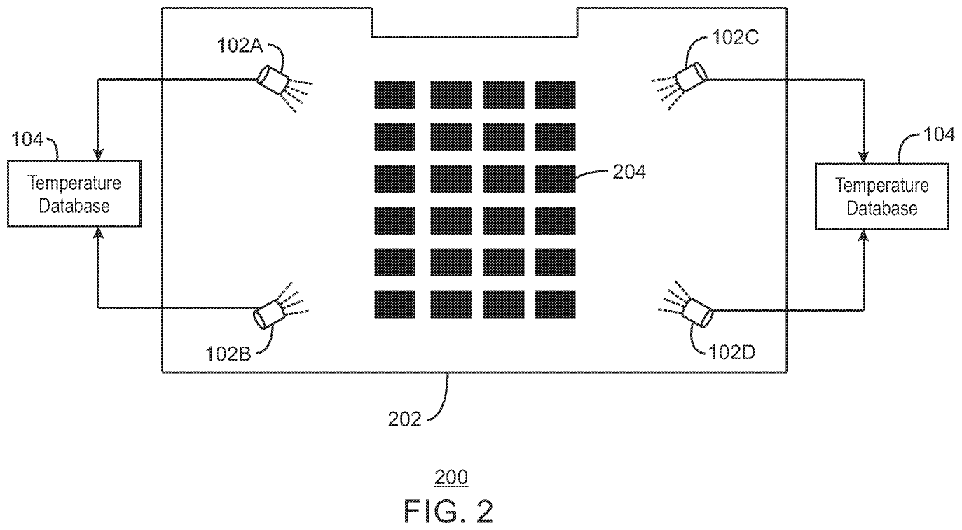

The same numbers are used throughout the disclosure and the figures to reference like components and features. Numbers in the 100 series refer to features originally found in FIG. 1, numbers in the 200 series refer to features originally found in FIG. 2, and so on.

### DETAILED DESCRIPTION

In accordance with the examples described herein, an estimation method is disclosed to detect an abnormal temperature from a thermal sensor and estimate a temperature value to replace the abnormal temperature based on temperature data of surrounding objects. Where multiple identical parts are additive manufactured, the estimation method utilizes historical and neighborhood trending to replace the abnormal temperature with an estimate. The result enables lamp exposure time compensation and correlation analysis to be performed.

FIG. 1 is a simplified block diagram of an environment 100 in which a method 120 for thermal control may operate, according to examples. The method 120 is utilized in a target zone in which multiple identical parts are being additive manufactured, such as a build bed. The method 120 receives temperature data from a thermal sensor 102 disposed in the target zone that is stored in a temperature database 104. While accumulating, the temperature data in the database 104 may be analyzed by the method 120 (online analysis), or the database 104 may be later accessed by the method 120 (offline analysis).

From the temperature data collected and stored in the database 104, the method 120 then performs abnormal temperature detection 106. Abnormal temperature detection selects the layer temperatures of each part not following its thermal trending. Once an abnormal temperature is detected, carriage obstructed layer detection 108 follows. The resulting abnormal temperature 110 is fed into an analysis engine 112, which includes, among other operations, both neighborhood trending estimation 114 and historical trending estimation 116.

In the analysis engine 112, the abnormal temperature 110 is compared to other temperatures in the nearby space of the target zone (neighbors) and to other temperatures that occurred before the abnormal temperature (history). Put another way, the analysis engine 112 detects the abnormal temperature(s) from the temperature database 104 and estimates temperature values based on a gradient in both space and time among neighboring objects. The analysis engine 112 includes both neighborhood 114 and historical trending 116 estimation, which are described in more detail below.

From these analyses, an estimated temperature assignment 118 is made, where an estimated temperature 122 replaces the abnormal temperature 110. In an example, the abnormal temperature 110 from the temperature database 104 is replaced with the estimated temperature 122 (shown in FIG. 1 as updated temperature database 124). The updated temperature database 124, which no longer has temperature “holes” due to improper temperature reading by the sensor 102, is available for programs such as lamp exposure time compensation 126 and correlation analysis 128, which may be used to improve operation of the target zone. A recommendation engine 130 is also available, for the detection of misaligned passes, as described below.

Additive manufacturing depends on appropriate thermal control and management during the printing process to get the desired properties. Real-time control and feedback for additive manufacturing is possible with high-resolution sensor readings of the powder and part temperature, as well as actuation of the agents and/or the lamp PWMs for corrective action. For accurate corrective action, abnormal values should be detected and rule out. But several corrective actions such as lamp exposure time compensation and correlation analyses cannot accept holes in the data. Thus, using the method for thermal control described herein, abnormal temperatures may be replaced with estimated temperatures. When the target zone contains several identical objects, the method not only detects the abnormal temperatures, but also closely approximates the actual temperatures, in some examples.

Normal drops and rises in the thermal trend of the parts are mainly due to natural variations of the additive manufacturing process or the closed loop feedback for the powder control. Uncontrolled factors like the wear in the mechanical movement of the carriages, the bumping of the FLIR camera and other localized events such as non-uniform spreading of the mechanical components, mischaracterization of passes during FLIR sequencing and conversion process in the printer may result in abnormal values.

FIG. 2 is a simplified diagram of a target zone 200 in which a plurality of substantially similar parts or objects 204 are additive manufactured as part of a single build, according to examples. As used herein, substantially similar parts refer to at least two parts in which one or more characteristics of the first part, such its shape, size, material, and so on, is the same or identical to the same characteristic of the second part. Thus, two parts formed based on the same object model and using identical materials would be substantially similar. In this example, the target zone 200 features a build bed 202. At the edge of the build bed 202 are four thermal sensors 102A, 102B, 102C, and 102D (collectively, “thermal sensors 204”) disposed strategically so as capture temperature data in the temperature database 104. Although four sensors 102 are shown, the principles described herein may be operable with fewer temperature sensors or with more temperature sensors. In some examples, the thermal sensors 204 are forward looking infrared radar (FLIR) cameras.

The sensors 102 transmit sensed temperature data to the temperature database 104, which may be coupled to the sensor. The collected temperature database may be directly coupled to the target zone, such as via a Universal Serial Bus (USB), Firewire, or other connection. Or, the database may be remote to the target zone, with the temperature data being transmitted wirelessly, such as by WiFi. The method for thermal control 120 may evaluate the temperature data from the database 104 while the sensors 204 are collecting the temperature information, an online application of the method. Or, the method 120 may operate following acquisition of the temperature data from the database, an offline application.

The abnormal temperature may result from an obstruction by a device that moves along a carriage or track of the target zone. Where the target zone is a build bed for additive manufacturing of parts, the device may be a lamp assembly, a pen enclosing ink jet print heads, a spreader roller, or other devices, as examples. These devices are referred to herein generally as carriage obstructions. When the target zone contains several objects that are substantially similar, such as the parts 204 in FIG. 2, the method 120 is capable of not only detecting the abnormal temperature but also estimating a temperature and replacing the abnormal temperature with the estimated temperature.

The abnormal temperature detected by the method 120 is associated with one of the substantially similar, or even identical, parts or objects that are together being additive manufactured in the target zone being monitored by the sensor(s). For some material analysis, a standard material shape known as a “dumbbell” or “dog bone” is used. The types of analysis that are performed on these dog bones includes ultimate tensile strength (UTS), elongation at yield, elongation at break (ESB), and modulus of elasticity, to name a few. An array of dog bones may be additive manufactured, such as to test materials being used or to test the printer specifications, as examples.

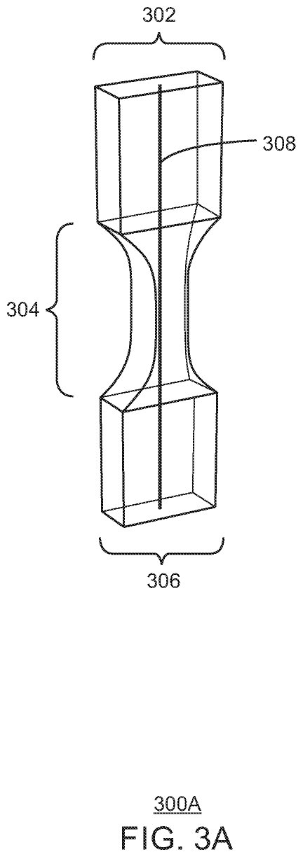

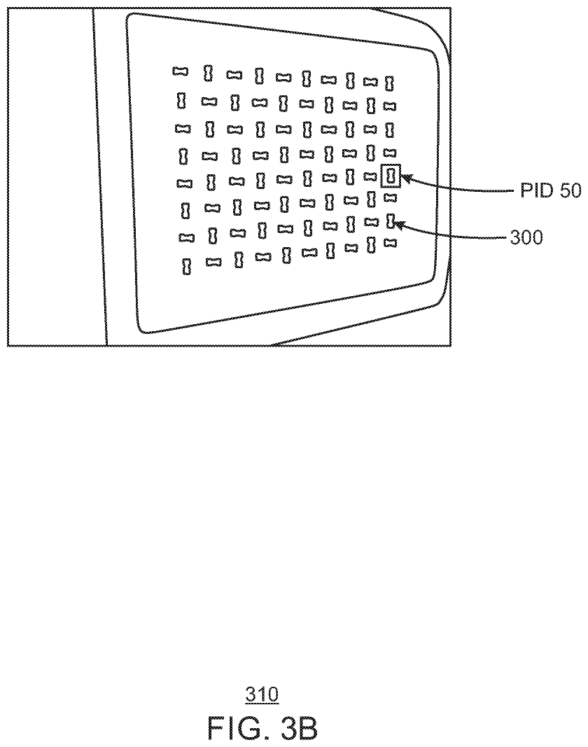

FIGS. 3A and 3B are illustrations of a dog bone 300 and a 10×8 array of dog bones 310 printed on a test bed, respectively, according to examples. In FIG. 3, the dog bone 300 is a part having head regions 302 and 306, and neck region 304. The dog bone 300 is a useful shape for analyzing the additive manufacturing process. Disposed centrally and within an interior portion of the part is a centroid 308 of the dog bone. Centroids are regions of interest for an object. The centroid 308 illustrated in FIG. 3 is centrally and vertically disposed along the length of the dog bone 300 such that a single pixel from each layer of the dog bone makes up the object centroid. Although a single centroid 308 is depicted, the dog bone 300 may have more than one object centroid.

FIG. 3B is an illustration of a 10×8 array 310 of dog bones 300, printed on a test bed. FIG. 3B shows a snapshot of the bed captured by a FLIR camera showing the layout of the bones in the 10×8 array. The first dog bone in the upper left of the array would be identified by position identifier (PID) 1, the one adjacent to the right would be identified by PID 2, and so on. A rectangle surrounds the dog bone in position identifier (PID) 50.

The dog bones are additive manufactured, layer by layer, by depositing powder material in the build bed, adding a liquid binding or fusing agent, and applying warming and or fusing heat. Each layer may have multiple passes, and each pass may have multiple functions taking place. For example, one pass may involve spreading powder, applying warming heat, and depositing a printing agent. The operations of additive manufacturing are varied and complex. Nevertheless, the method for thermal control described herein is operable under different additive manufacturing operating environments, and is capable of performing separate analysis for each pass of additive manufacturing that takes place.

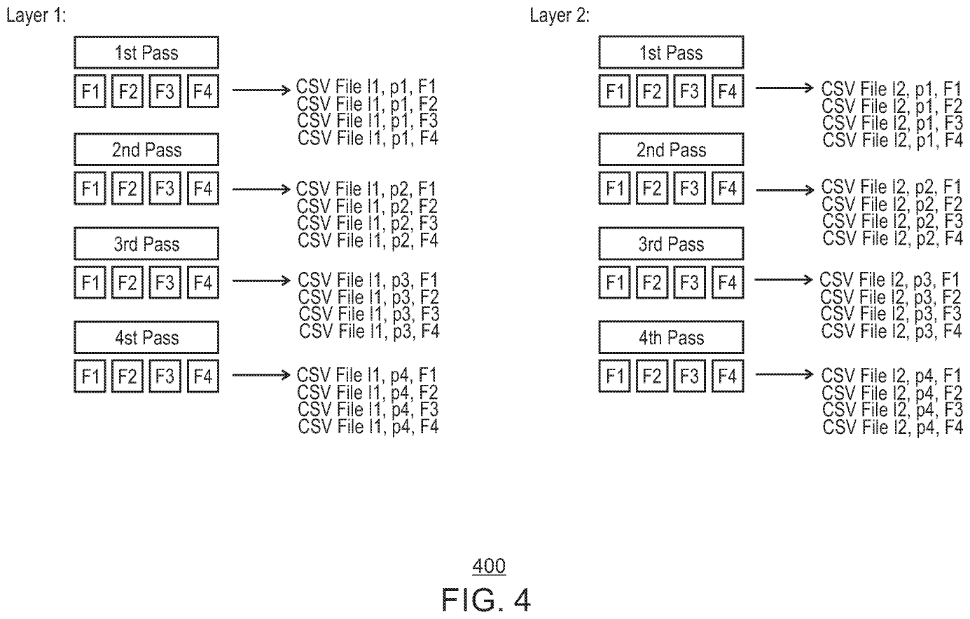

FIG. 4 is a simplified illustration of the temperature data gathering of the thermal sensors, according to examples, such as the sensors 102 in FIGS. 1 and 2. This example considers two layers of a part being additive manufactured. Each layer has four passes. The thermal sensors capture four frames of data with each pass. Each frame of data is converted to a comma separated values (CSV) file for subsequent analysis.

In this example, for each layer of temperature sensing of a single part, sixteen CSV files are generated. Where eight frames per layer are captured, 32 CSV files would be generated for each layer. Where the target zone is sensing temperature for multiple parts, and since each part may have a hundred layers or more, the database supporting the sensed temperatures within the target zone may be quite large.

In the dog bones example of FIG. 3B, the FLIR sensor samples four frames per pass for each layer. One snapshot of the sensor captures the temperature of the target zone (e.g., the build bed) and stores the thermal data in a matrix of 480 rows×640 columns (with the matrix size being related to the resolution of the FILR sensor). After the frames are acquired, they are sequenced (for layers and passes) and converted to CSV files for analysis. Mis-assigned passes, if any, result from this conversion process due to synchronization mismatch between the FLIR triggers and other timing issues.

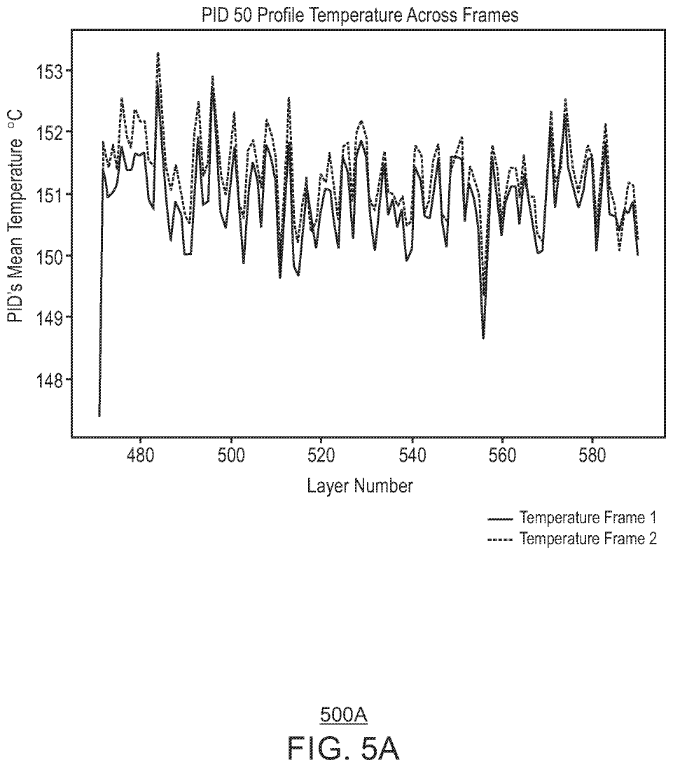

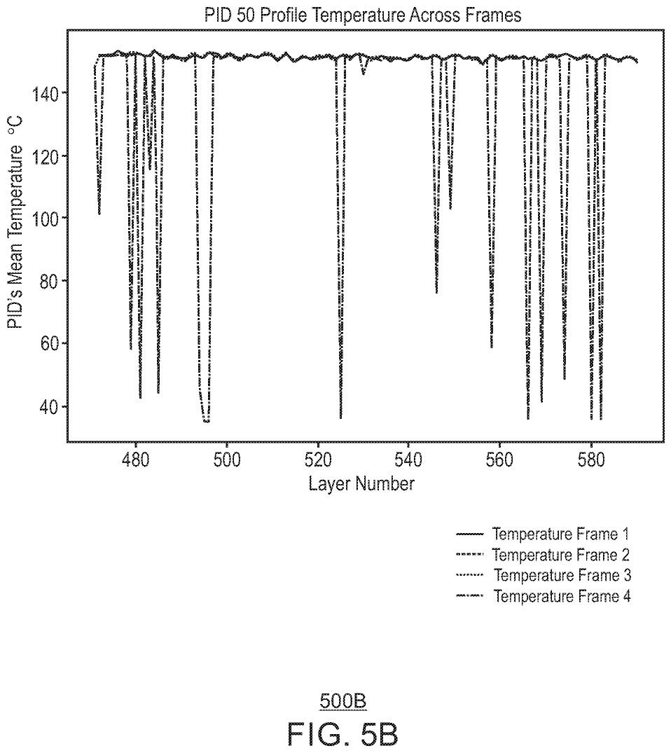

FIGS. 5A and 5B shows a thermal profile of the part with PID 50 (located at the 4th row and in the 10th column of the bed in FIG. 3B), according to examples. FIG. 5A shows the thermal profile 500A of the part across the neck region layers for two frames, denoted frames 1 and 2. Layers 460-600 (x-axis) with mean temperatures between 147 and 154° C. (y-axis) are observed. Along these ranges, the thermal profile 500A preserves a common trending along the two frames.

Nevertheless, FIG. 5B shows the thermal profile 500B of the same part with PID 50, but includes also frames 3 and 4. As in the graph 500A, layers 460-600 (x-axis) are observed, but the temperature range differs from that of FIG. 5A. In FIG. 5B, mean temperatures between 35 and 150° C. (y-axis) are observed. In FIG. 5B, the solid line (frame 1), dashed line (frame 2), and dotted line (frame 3) follow similar thermal trending, whereas the dot-dashed line (frame 4) does not follow the trend of the other frames. In frame 4, several sudden and significant drops in temperature are observed. This suggests that the sudden change in temperatures on frame 4 (dot-dashed line) corresponds to obstructions of the sampling data, mischaracterization of the sampling data, or mislabeling of FLIR files during the data acquisition and conversion process.

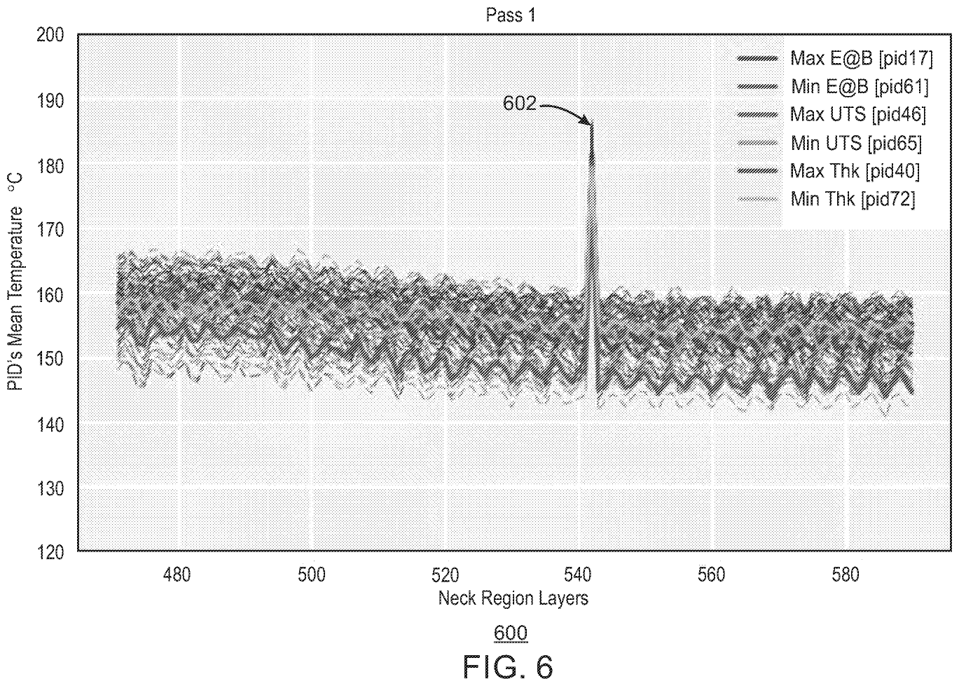

FIG. 6 is a graph 600 featuring profile temperatures of the dog bones in the test bed of FIG. 3, according to examples. Recall from FIG. 3 a plurality of dog bones 302 in a 10×8 array, with each dog bone having a unique position identifier (PID). The graph 600 plots neck region layers between 460 and 600 (x-axis) versus mean temperatures between 120 and 200° C. For each dog bone, the mechanical property offline analysis gives a qualitative value on different aspects (UTS, E@B, etc.). The graph 600 shows the thermal profile of each bone in the neck region layers. Some dog bones (thermal profiles) are highlighted because that particular bone presents the min/max E@B/UTS/thickness value among all the bones in the build.

At a peak 602 in the graph 600, a general raising of the dog bone temperatures by about 20° C. is observed. The lines indicated by the legend represent characteristics of dog bones at PIDs 17, 61, 46, 65, 40, and 72. The dull lines represent other dog bones of the 10×8 array which do not have the desired mechanical strength characteristics.

The observed peak 602 is experienced by all the dog bones. The graph 600 shows that the temperature peak is not confined to a local region of the target zone. Thus, rather than indicating an abnormal temperature, the peak 602 may indicate a mislabeled pass for a FLIR image.

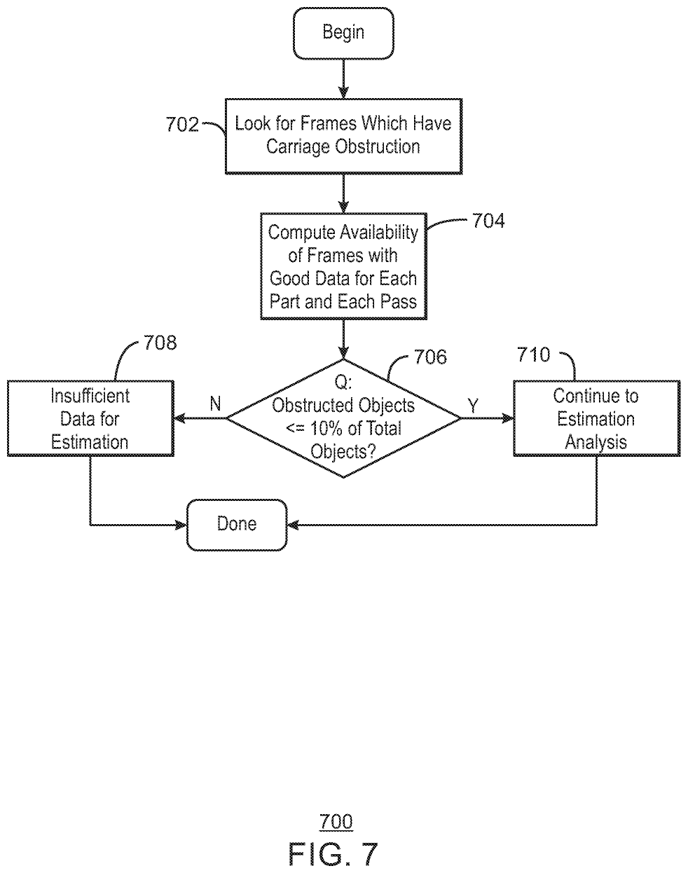

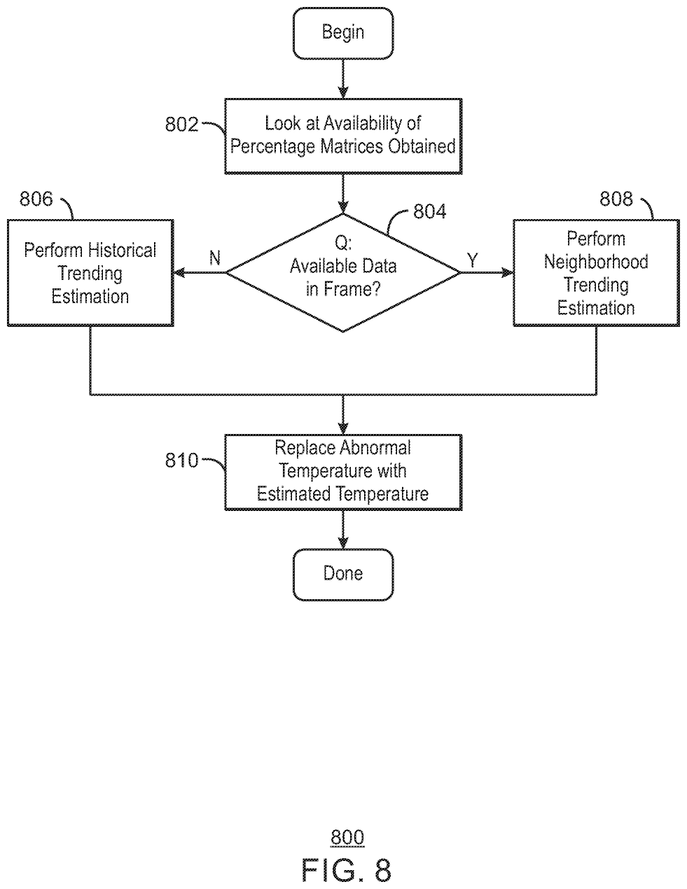

With this information in mind, FIGS. 7 and 8 are flow diagrams 700 and 800, respectively, to illustrate operations of the method for thermal control 120 introduced in FIG. 1. The operations 700 look for frames in which carriage obstruction is present, thus determining whether estimating temperature is possible while the operations 800 perform the actual temperature estimate, according to examples.

In FIG. 7, the method looks for frames which have carriage obstruction (block 702). For the above dog bones example, temperature in the 40-50° C. range indicate carriage obstruction. So, frames indicating those temperatures would be selected. The raw FLIR frames are mapped to one or more centroids to detect the expanse of the carriage obstruction. Simultaneously, the availability of frames with good data is computed for each part and for each pass (block 706). Availability data refers to how many layer temperatures per part, in a given pass, are classified as normal temperatures.

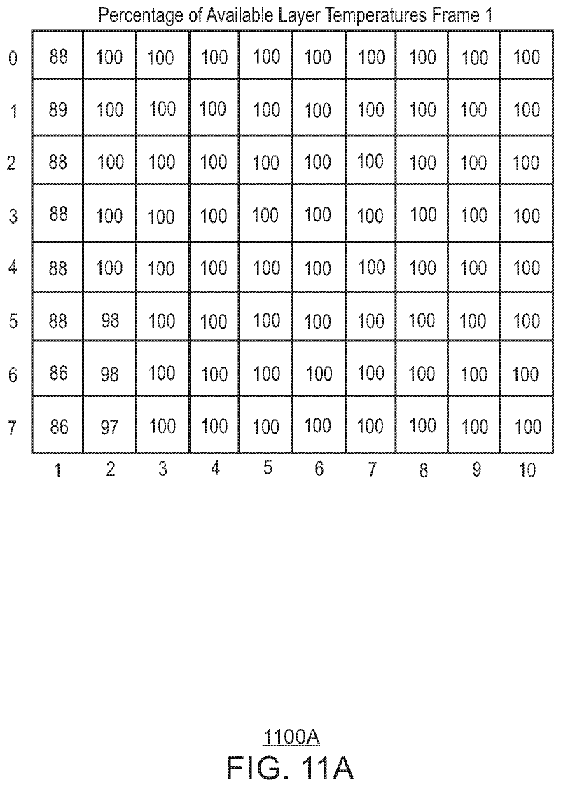

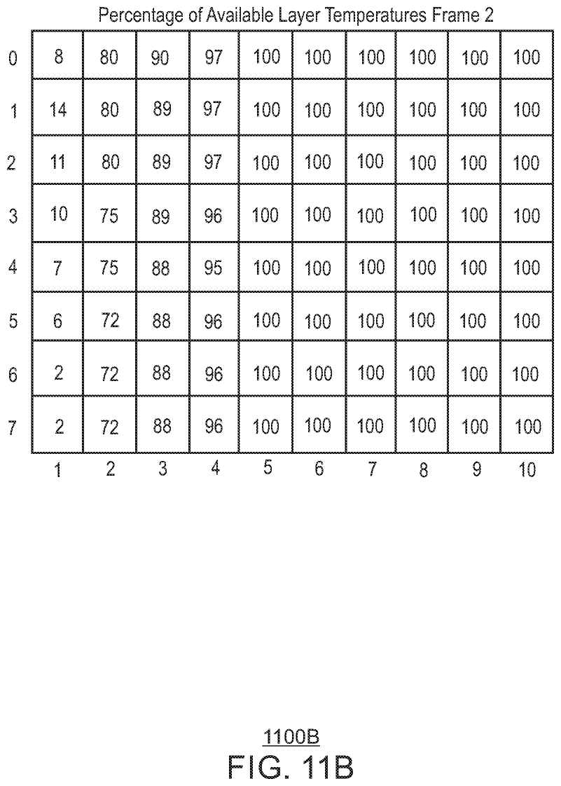

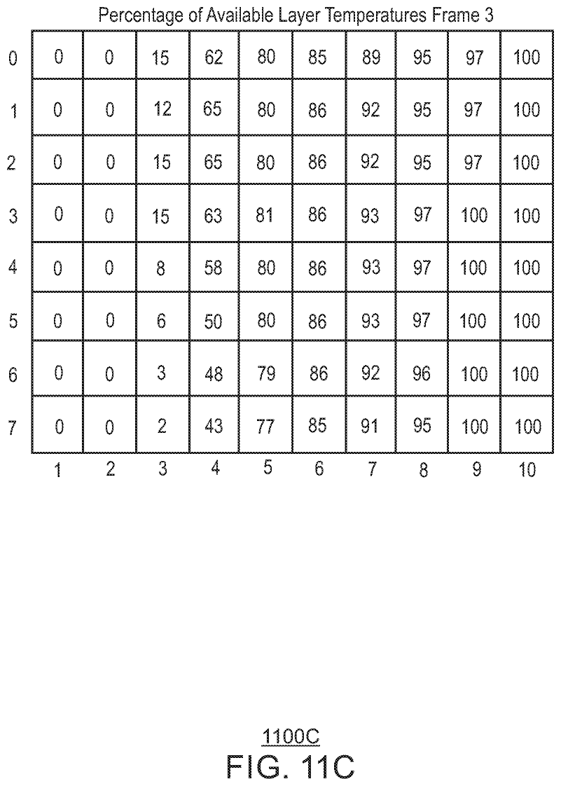

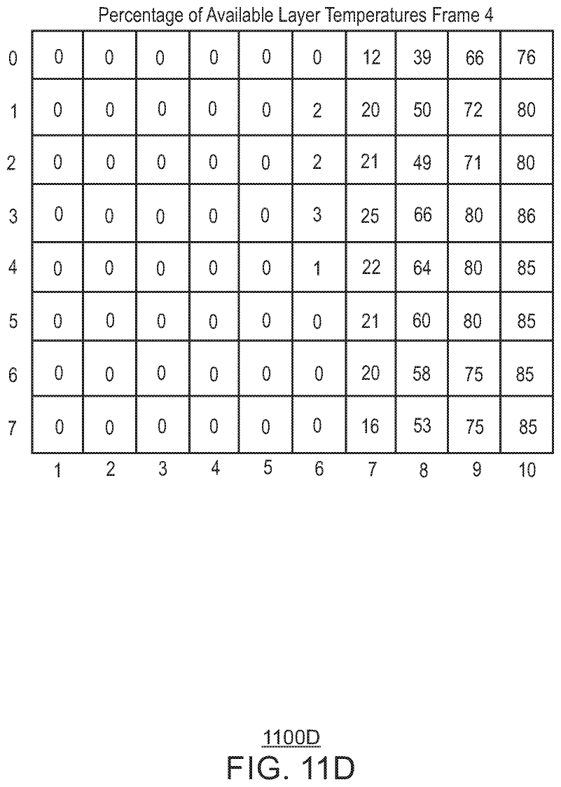

Availability matrices are the percentage of not obstructed layer temperatures in the entire set of layers of a part. As used herein, if abnormal temperatures have been detected in ten layers of a part and the part has a hundred layers, then the part is deemed to have 90% availability. Percentage availability matrices are the output of the abnormal temperature detection, which happens before the operations of FIG. 7 (see block 106 in FIG. 1). Availability matrices are illustrated in FIGS. 11A-11D, below.

If the number of obstructed parts is small, the method for thermal control is capable of estimating a temperature to replace an abnormal temperature reading. If instead a large number of parts is obstructed such that the thermal sensor is unable to accurately record temperatures, the method is unable to perform its estimation. Therefore, in FIG. 7, a query is made about the number of obstructed parts. If the number of obstructed parts is less than 10% of the total number of parts in the target zone (block 708), the estimation analysis can proceed (block 712). Otherwise, there is insufficient data for making such an estimation (block 710).

Once it has been determined that the temperature data is suitable for estimation, FIG. 8 shows the operations 800 of the method to do temperature estimation, according to examples. First, the method looks at the availability of percentage matrices obtained (block 802). If the set of parts with 100% of availability is not empty, a neighborhood trending estimation scheme is applied, based on thermal trending of the neighborhood of a part to estimate carriage obstructed layers (block 808). If, instead, the set of parts with 100% of availability is empty, a historical trending detection scheme is applied (block 806), which is based on the thermal trending of previous frames to estimate carriage obstructed layers. Once one of these estimation operations is complete, an estimated temperature may replace the abnormal temperature that triggered the method (block 810). Several of these operations are described in more detail in the following paragraphs.

Carriage Obstructed Layer Detection

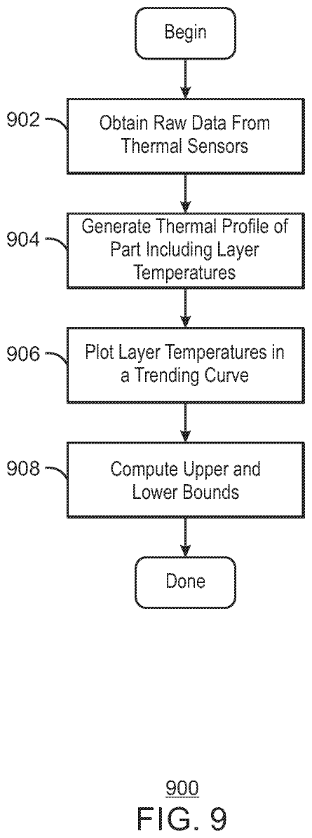

FIG. 9 is a flow diagram showing operations of the carriage obstructed layer detection 106 portion of the method for thermal control 120, according to examples. Recall from FIG. 1 that the method 120 commences when the thermal sensor 102 provides data to a temperature database 104 with which carriage obstructed layer detection 106 takes place. Likewise, in FIG. 9, the carriage obstructed layer detection 106 obtains the raw data from one or more thermal sensors (block 902). From this raw data, a thermal profile of the part, including its temperature at multiple layers, can be derived (block 904). From the thermal profile, a trending curve of the layer temperatures may be plotted (block 906). In one example, the trending curve is a polynomial of degree k fitting a given set of points while minimizes the squared error. From the trending curve, upper and lower bounds are computed (block 908). In one example, the lower bound is obtained by the trending curve multiplied by a factor of 1−a, with 0<α<1. The lower bound establishes a threshold for the temperatures on each layer. Thus, each layer temperature below the lower bound is a candidate of abnormal value on the thermal profile of the object. In one example, an upper bound is also obtained by multiplying the trending curve by a factor of 1+α.

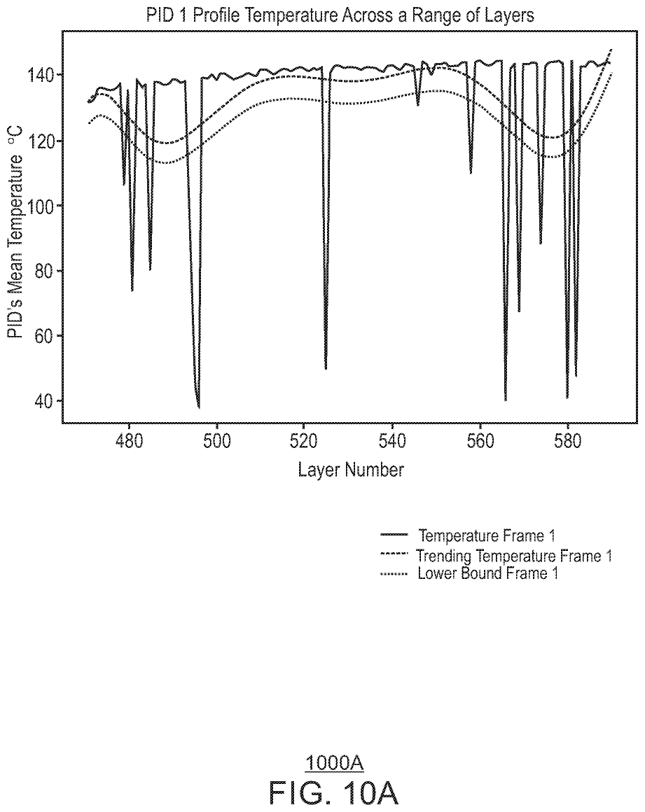

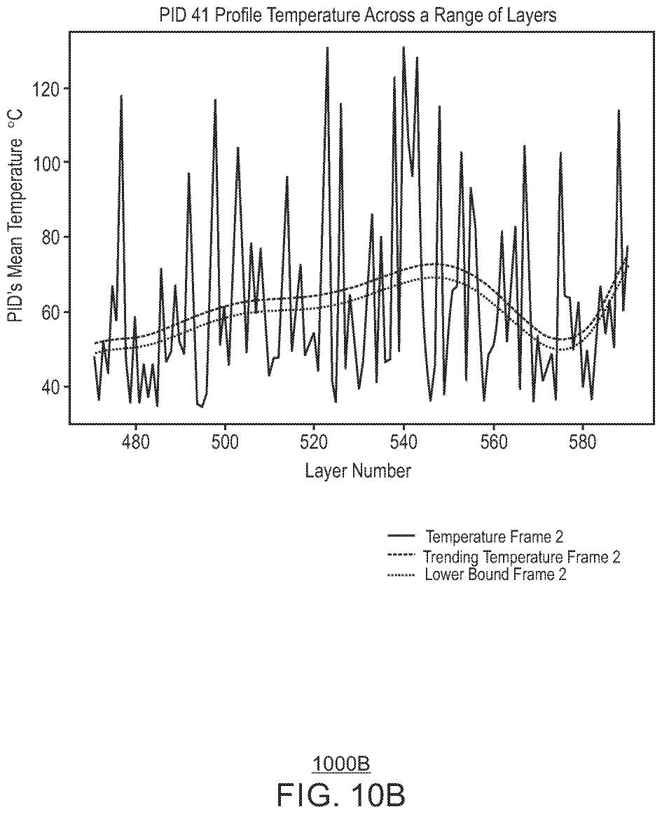

FIGS. 10A and 10B are graphs 1000A and 1000B, respectively, showing the thermal profile for two different dog bones (FIG. 3), according to examples. The graph 1000A shows the thermal profile of PID 1 in frame 1 while the graph 1000B shows the thermal profile of PID 41 in frame 2. In the graph 1000A, the dashed line shows the trending curve based on a degree 8 polynomial, and the short-dashed line shows the lower bound for the PID 1 with α=0.05. From the thermal profile of objects with high (e.g., 100%) availability, as in FIG. 10A, the temperature fluctuation range goes from 120 up to 160° C.

Depending on how much of the visibility of the FLIR sensor is obstructed by the carriage, the graph 1000B illustrates that the layer temperatures of the measured part fluctuate from 40° C. up to 160° C. Since a part on the bed may be completely obstructed by the carriage, there are thermal profiles reporting fluctuating temperatures almost in every layer. Such is the case of the thermal profile of PID 41, shown in FIG. 10B. From the graph 1000B, the trending curve of the PID 41 is placed between 40 and 80° C., meaning that most of its layer temperatures are abnormal values.

When the median of the trending curve is out of the normal temperature fluctuation range, as in the case of PID 41, the percentage of availability is computed considering only the layer temperatures above 120° C. In some examples, abnormal layer temperatures fluctuating between 40 and 60° C. are considered carriage obstructed layers.

Once the lower bound is obtained, the method 120 gets a matrix of availability having the percentage of each part in the bed. FIGS. 11A-11D are matrix of availability diagrams showing carriage obstruction across frames. Each entry shows dog bone centroids, with the percentage of layer temperatures (across a range of layers) above its thermal bound.

The image 1100A (FIG. 11A) is a 10×8 matrix showing the percentage of available layer temperatures for frame 1. All eight percentages in the first column are below 100%. In the second column, the last three entries are below 100%. In all remaining columns, the percentage of available layer temperatures is 100%.

The image 1100B (FIG. 11B) is also a 10×8 matrix, and shows the percentage of available layer temperatures for frame 2. In frame 2, the last six columns show 100% availability, but the first four columns show less than 100%, with the first column showing lower numbers than the second column, and so on.

The image 1100C (FIG. 11C) shows frame 3, and only the last column shows 100% availability. In the fourth frame, the image 1100D (FIG. 11D), none of the columns shows 100% availability.

Matrix of availability are useful to apply detection of abnormal values considering whether neighborhood trending temperatures or thermal trending of the neighbors in previous frames.

Neighborhood Trending Scheme

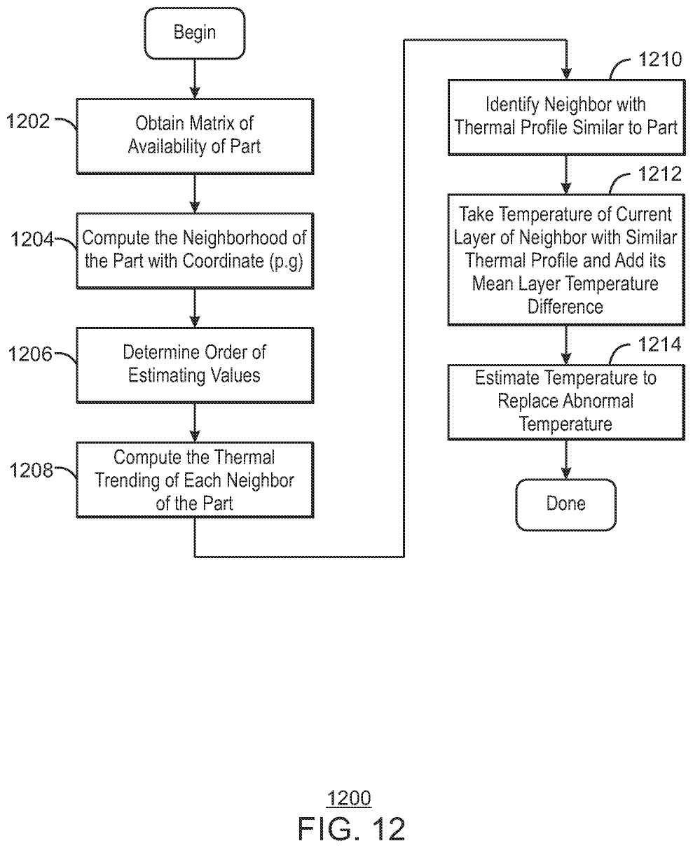

Recall that the method for thermal control uses neighborhood trending estimation when there are enough neighbors available in the current frame. FIG. 12 is a flow diagram illustrating operations performed by the neighborhood trending estimation, such as the neighborhood trending estimation 808 of FIG. 8. Given a frame and the corresponding matrix of availability with n rows and m columns (block 1202), carriage obstructed layers of a part are estimated by considering the thermal trending of its neighborhood. The neighborhood of a part with coordinate (i, j) is formed by all the parts with coordinates (p, q), with i−b≤p≤i+b and j−b≤q≤j+b, for a given integer 0≤b≤max(n,m) (block 1204).

The method for thermal control follows the topological sorting on the parts, based on the 100% availability of its neighbors, to determine the order of estimating the values (block 1206). The method then computes the thermal trending of each neighbor of the part having carriage obstructed layers (block 1208). The method identifies a neighbor with similar thermal profile by looking for the thermal trending of a neighbor who's mean layer temperature difference is smaller with the thermal trending of the current part (block 1210). The method estimates the abnormal layer temperatures (block 1214) by taking the temperature of the current layer of the neighbor with similar thermal trending and adding its mean layer temperature difference (block 1212).

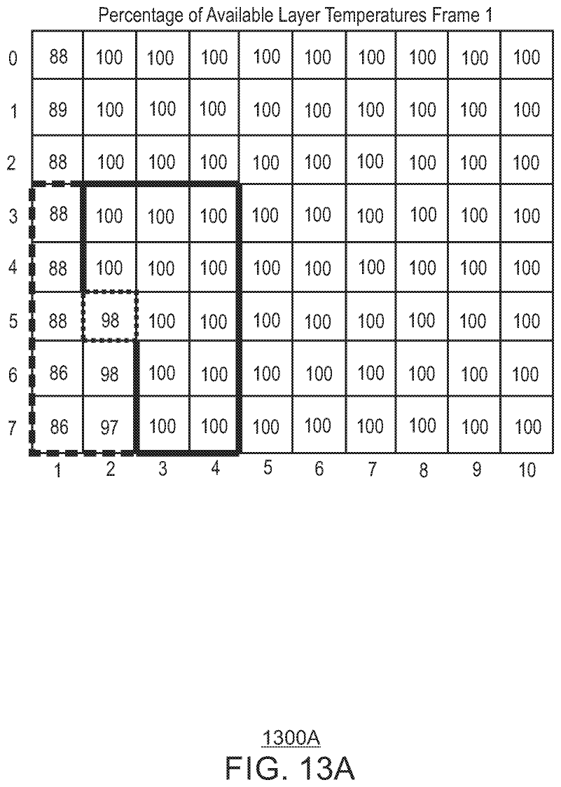

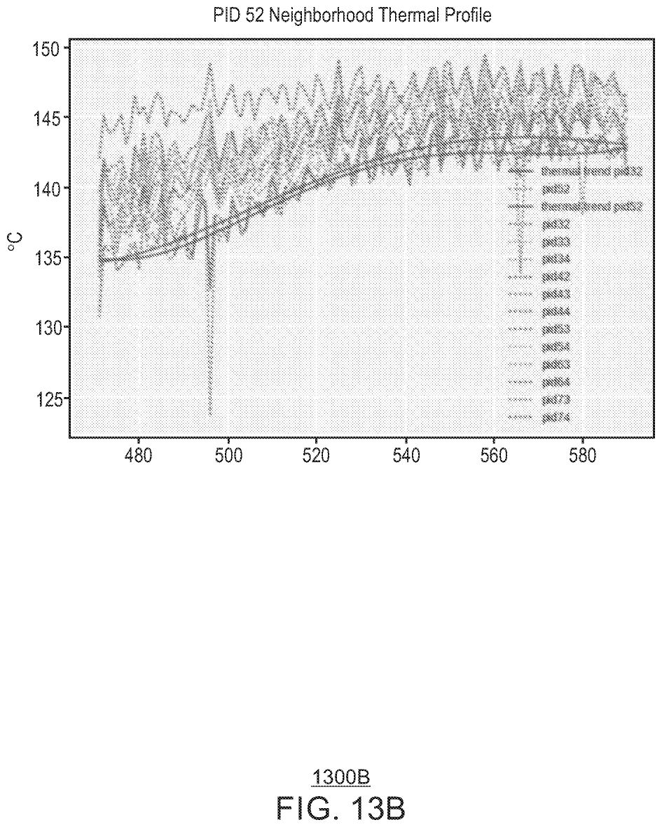

FIGS. 13A and 13B show the matrix of availability 1300A for PID 52 and the thermal profile 1300B of the neighborhood of PID 52, according to examples. FIG. 13A shows the case of PID 52. The image 1300A is a heat map of the availability layer temperatures per object in frame 1. The dotted rectangle shows the neighborhood of PID 52 with b=2 (PIDs 30-33, 40-43, 50-53, 60-63, and 70-73). The thick polygon encloses the neighbors of PID 52 with 100% availability (PIDs 31-33, 41-43, 52-53, 62-63, and 72-73). The position of PID 52 is marked with a dashed square. FIG. 13B shows the thermal profile of the neighborhood of PID 52. A solid line shows the trending of the neighborhood of PID 52. A second solid line corresponding to PID 32 is the most similar thermal trending to PID 52.

Similarity between two position IDs A, B in a range of layers L₁, L₂ is defined as the value (e.g., the thermal difference) obtained by adding the absolute difference of temperature PID_{A} minus temperature PID_{B} in a layer x, for x in L₁<=x<=L₂. Most similar PIDs refer to a PID couple having minimum thermal difference. In FIG. 13A, for example, the most similar neighbor for PID 32 is PID 52, since their thermal difference is minimal across the PID 32 neighbors.

The method applies neighborhood trending estimation method on carriage obstructed layers, and continue the estimation in the rest of parts with less than 100% availability until finished with the parts on the bed. In examples, the method for thermal control 120 is limited by the availability of the data in a given frame. If there is not enough available data, the method looks at the part with the most similar gradient to the part having the abnormal temperature.

Historical Trending Scheme

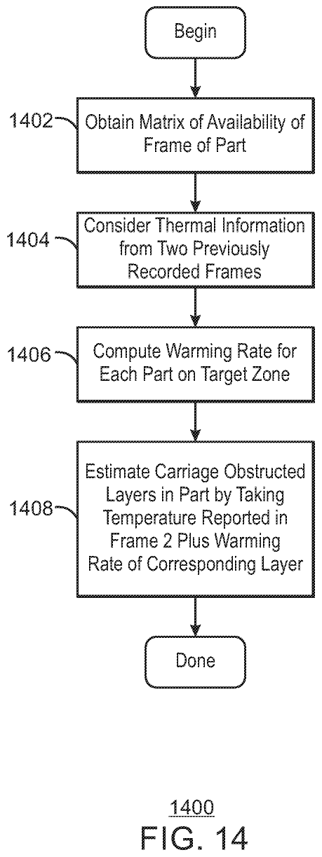

FIG. 14 is a flow diagram 1400 showing operations performed during historical trending estimation, such as the historical trending estimation 806 (FIG. 8), according to examples. Given a frame and the corresponding matrix of availability (block 1402), the method for thermal control 120 estimates carriage obstructed layers of a part considering the thermal information of its previously two recorded frames, say frame 1 and frame 2 (block 1404). For each part on the target zone, the method 120 computes its warming rate (block 1406), considering the difference of temperature in frame 2 minus frame 1 on each layer. The method then estimates carriage obstructed layers in such part by taking the temperature reported in frame 2 plus the warming rate of the corresponding layer (block 1408).

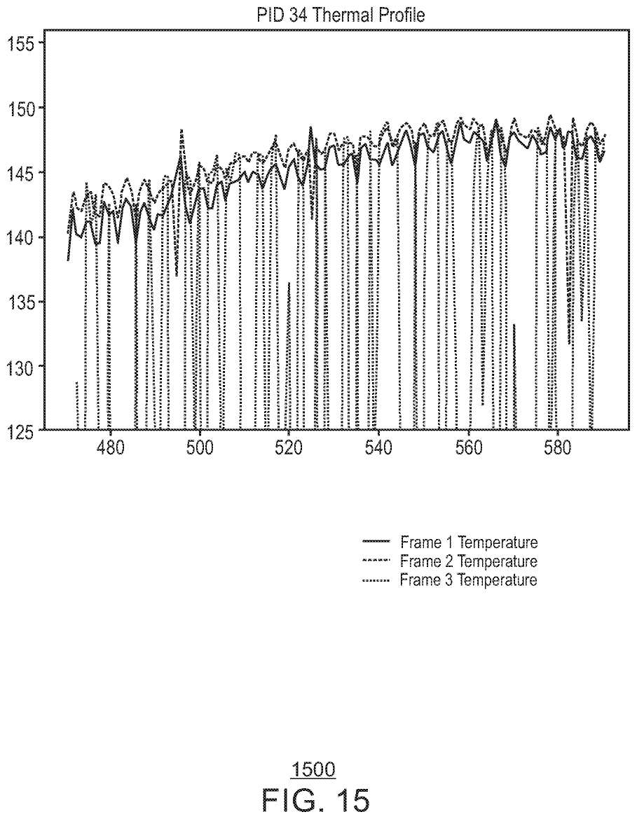

FIG. 15 is a graph 1500 illustrating the thermal profile of PID 34 in frames 1, 2 and 3. Frame 3 presents carriage obstructed layers that are estimated based in the warming rate considering frame 1 and 2.

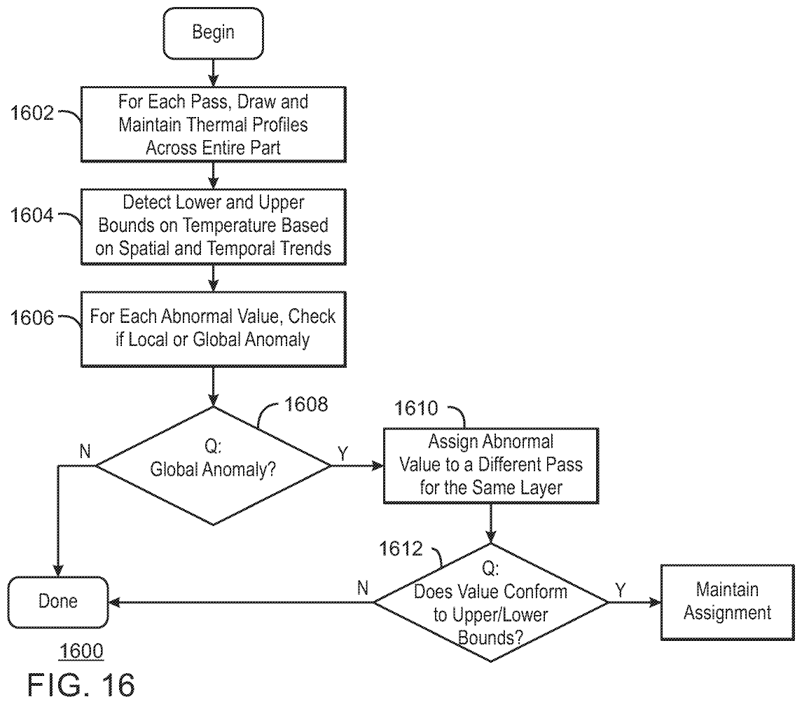

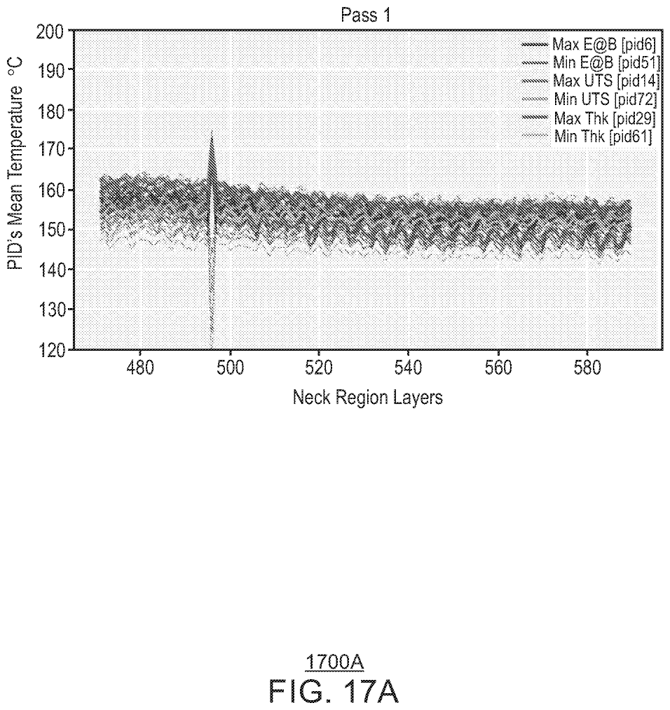

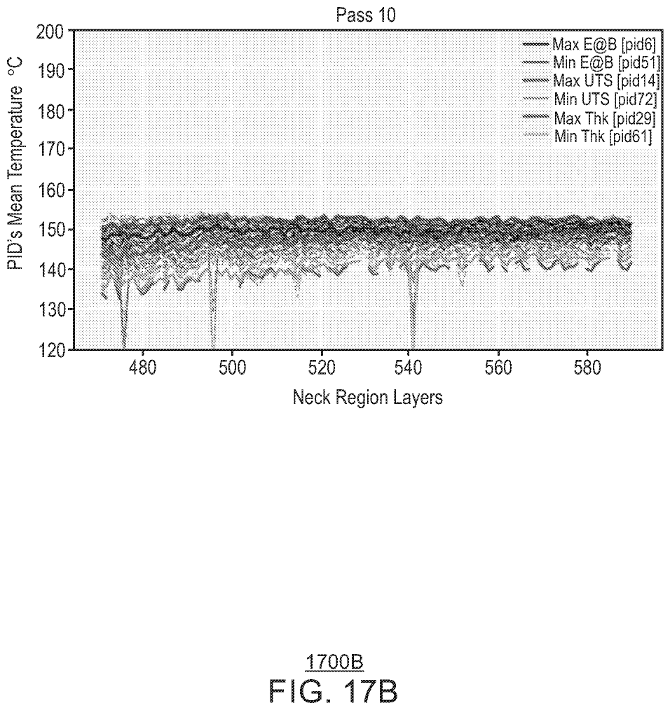

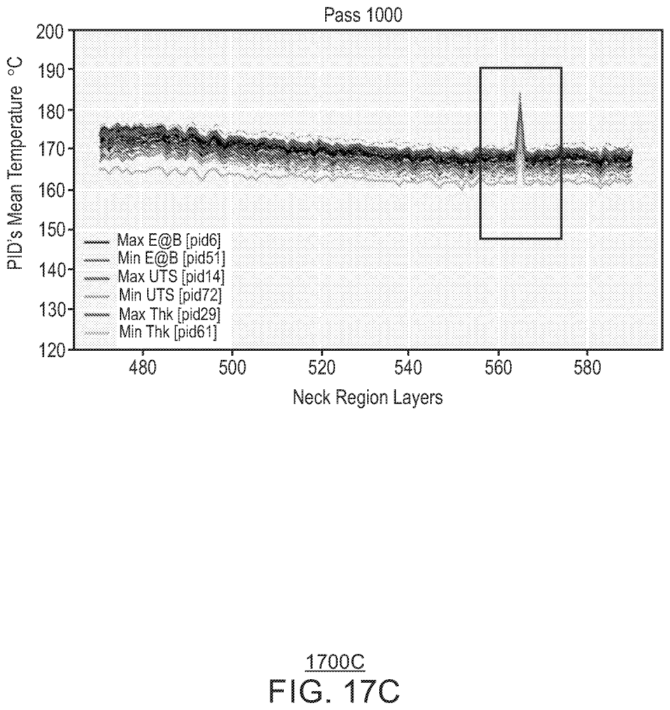

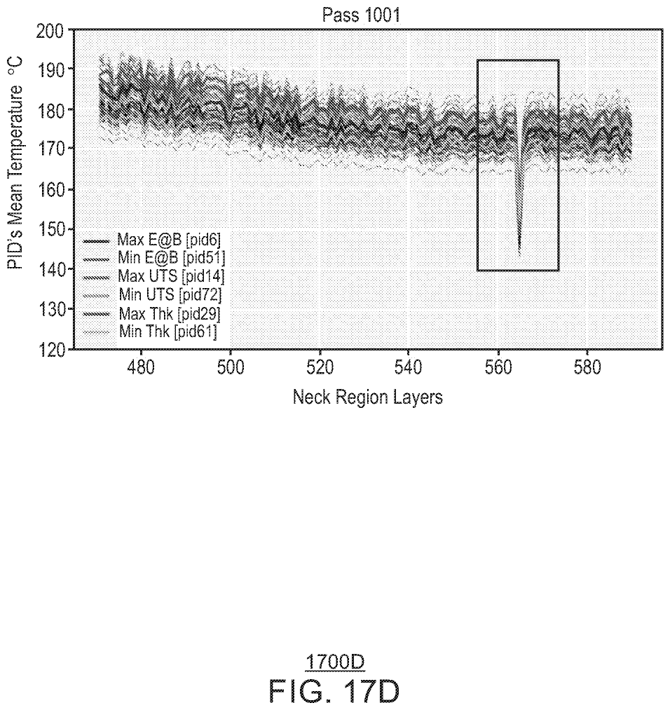

Returning to FIG. 1, the method for thermal control 120 also includes a recommendation engine 130 for the detection of mis-assigned passes, according to examples. FIG. 16 is a flow diagram 1600 showing operations of the recommendation engine 130 of the method of FIG. 1, according to examples. For each pass, the recommendation engine draws and maintains the thermal profiles across the entire part (block 1602), as illustrated in FIGS. 17A-17D, below. The recommendation engine also detects the lower and upper bounds on the temperature based on the spatial and temporal trends (block 1604). For each of the identified abnormal values in a given pass, the recommendation engine checks whether the value is a global anomaly or a local one (block 1606). As an example, the recommendation engine would check whether the abnormal temperature is a peak for all the dog bones or some of the dog bones.

If the identified value is a global anomaly (block 1608), the recommendation engine assigns the abnormal temperature to a different pass (for the same layer) (block 1610). The recommendation engine also checks whether the reassignment will make the abnormal temperature conform to the lower and upper bounds for that pass (block 1612). If there are more than two candidate passes for that abnormal value, flag the conflict and ask the operator to help. The operator may want to reconvert the file, or change the labels or exclude those files from the analysis.

FIGS. 17A-17D are graphs used by the recommendation engine, according to examples. Thermal profiles are depicted in the neck region for a given build. The rectangles in FIGS. 17C and 17D show the peak in fuse 1 around layer 560 and a dip in temperatures for fuse 2 around the same layer. Since both the abnormalities affect all the dog bones, the recommendation engine has identified mislabeled passes for a given layer. Thus, the method for thermal control may be used to identify mis-assignment of passes to the raw FLIR images.

In summary, the method for thermal control is capable of detecting abnormal temperatures using temporal and spatial trends to approximate actual temperature data. The method may also dynamically decide the number of neighbors needed to determine the spatial trend, based on the availability of good data. The method may also estimate the temperatures where the abnormal temperatures were detected because of occlusion of the target zone, such as by a carriage. And, the method includes a recommendation engine to identify mis-assignment of passes to the FLIR images by identifying abnormal values occurring throughout the target zone.

The method for thermal control may operate in offline or online modes. In offline mode, raw data is stored and accessible to query. In online mode, an input feed flow of frame data is accessed per layer. In examples, the offline mode may further use mechanical strength data in addition to FLIR data to estimate the actual temperatures for the obstructed parts.

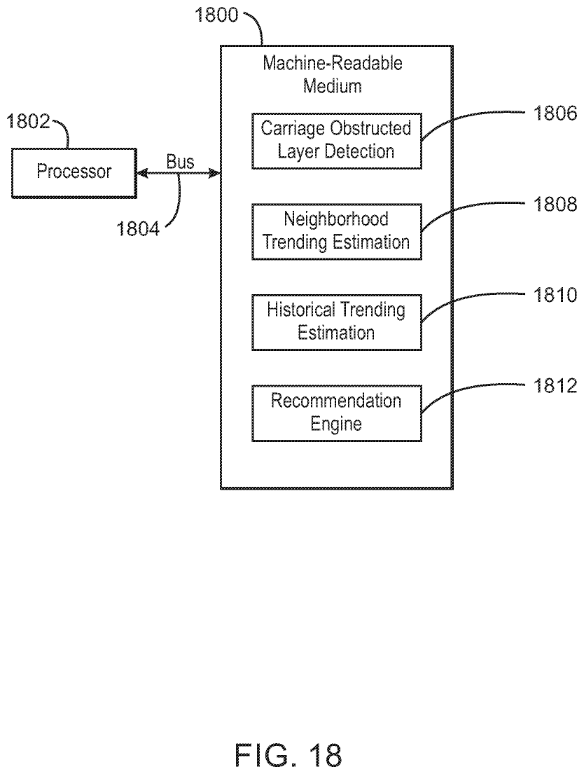

FIG. 18 is a diagram of an exemplary non-transitory machine-readable medium 1800 including code or instructions to direct a processor 1802 to implement the method for thermal control, according to examples. The processor 1802 may access the non-transitory, machine-readable medium 1800 over a bus 1804. The non-transitory, machine-readable medium 1800 may include storage such as the storage 1808.

The non-transitory machine-readable medium 1800 may include code, such as a software program, to perform carriage obstructed layer detection 1806, such as in FIG. 7. The non-transitory machine-readable medium 1800 may also include code to perform neighborhood trending estimation 1808, such as in FIG. 12. The non-transitory machine-readable medium 1800 may also include historical trending estimation 1810, such as in FIG. 14. And, the machine-readable medium 1800 may include a recommendation engine, such as in FIG. 16.

While the present techniques may be susceptible to various modifications and alternative forms, the techniques discussed above have been shown by way of example. It is to be understood that the technique is not intended to be limited to the particular examples disclosed herein. Indeed, the present techniques include all alternatives, modifications, and equivalents falling within the scope of the following claims.

What is claimed is:

1. A method comprising:
detecting an abnormal temperature based on temperature readings received from a sensor disposed in a target zone, the target zone to receive build material for the additive manufacture of a plurality of similar parts; and
replacing the abnormal temperature with an estimated temperature.

2. The method of claim 1, further comprising extracting from the temperature readings one or more regions of interest, wherein the temperature readings comprise data from each layer, and each layer comprises one or more passes, and each pass comprises one or more frames.

3. The method of claim 2, further comprising:
computing an availability of one or more frames in which the abnormal temperature is not found.

4. The method of claim 1, further comprising:
generating a thermal profile, the thermal profile comprising the temperature readings from the sensor over a plurality of layers.

5. The method of claim 2, further comprising performing a neighborhood trending estimation of one or more parts of the plurality of parts within a region of interest.

6. The method of claim 2, further comprising performing a historical trending estimation of the plurality of parts within a region of interest.

7. An apparatus comprising:
a thermal sensor disposed on a target zone, wherein a part and a plurality of substantially similar parts are to be additive manufactured in the target zone; and
an analysis engine to:
receive a plurality of temperature readings from the thermal sensor;
detect an abnormal temperature among the plurality of temperature readings; and
replace the abnormal temperature with an actual temperature based on analysis of a region of interest of the part.

8. The apparatus of claim 7, the analysis engine to further perform carriage obstructed layer detection by:
generating a thermal profile of the part based on the plurality of temperature readings, wherein the plurality of temperatures further comprises layer temperatures of the part; and
plotting the layer temperatures in a trending curve.

9. The apparatus of claim 8, further comprising:
computing a lower bound of the trending curve.

10. The apparatus of claim 7, wherein the plurality of temperatures is obtained online.

11. The apparatus of claim 7, wherein the plurality of temperatures and mechanical strength information is obtained offline.

12. A machine-readable medium having instructions stored therein that, in response to being executed on a computing device, cause the computing device to:
detect an abnormal temperature based on a probability matrix of temperature readings received from a sensor disposed in a target zone, the target zone to receive build material for the additive manufacture of a plurality of similar parts; and
performing a neighborhood trending estimation of one or more parts of the plurality of parts within a region of interest, resulting in an estimated temperature.

13. The machine-readable medium of claim 12, wherein the estimated temperature replaces the abnormal temperature during lamp exposure time compensation analysis of the target zone.

14. The machine-readable medium of claim 12, wherein the estimated temperature replaces the abnormal temperature during correlation analysis of the target zone.

15. The machine-readable medium of claim 12, further causing the computing device to:
execute a recommendation engine to detect misaligned passes.
